(19) United States
(12) Patent Application Publication
(10) Pub. No.: US 2002/0046655 A1
(43) Pub. Date: Apr. 25, 2002

(54) Method and system for recovering VOC emissions

(76) Inventors: Wu-Hsiung Ernest Hsu, Tualatin, OR (US); James A. Evensen, Tualatin, OR (US)

Correspondence Address: MARGER JOHNSON & MCCOLLOM PC, 1030 SW MORRISON STREET, PORTLAND, OR, 97205, US

(21) Appl. No.: 10/016,429

(22) Filed: Nov. 1, 2001

Related U.S. Application Data
(63) Continuation-in-part of application No. 09/859,821, filed on May 16, 2001.
(60) Provisional application No. 60/204,469, filed on May 16, 2000.

(51) Int. Cl. B01D 46/00

(52) U.S. Cl. 95/273; 55/385.1; 264/102; 425/74

(57) ABSTRACT

A method for recovering VOC and HAP emissions in the production of a lignocellulosic product is provided. The method comprises forming a mat of lignocellulosic material by bonding together and mat in a product formation press with an adhesive material to produce the lignocellulosic product. VOC and HAP emissions are produced during the formation of the lignocellulosic product in a product formation press. The VOC and HAP emissions produced are withdrawn during the formation of and lignocellulosic product prior to removal of the lignocellulosic product from the product formation press. Then, the VOC and HAP emissions which are withdrawn from the formation press are recovered without releasing same to the atmosphere. The product formation press is substantially closed to the surrounding atmosphere.

### RELATED APPLICATION

This application is a continuation-in-part of U.S. Ser. No. 09/859,821, filed May 16, 2001, which claims priority from Provisional Application Serial No. 60/204,469 filed on May 16, 2000.

### BACKGROUND OF THE INVENTION

This invention relates to methods and systems for recovering a substantial amount of the volatile organic compounds (“VOC”) and Hazardous Air Pollutant emissions (HAP), respectively, which are produced during the formation of composite wood products, such as for example, fiberboard, particleboard and the like.

Products such as fiberboard and particleboard have been found to be acceptable alternatives in most cases to natural wood paneling, sheathing and decking lumber. Fiberboard and particleboard are produced from wood particles bonded together by an adhesive, the adhesive being selected according to the intended use of and the properties desired for the finished product. Often times, the adhesive is combined with other additives to impart additional properties to the lumber. Additives can include fire retardants, insect repellants, moisture resistants, fungus resistants and color dyes. A significant advantage of fiberboard and particleboard lumber products is that they have many of the properties of plywood, but can be made from lower grade wood species and waste from other wood product production. These products also can be formed into lumber in lengths and widths independent of size of the timber as harvested.

A major reason for the increased presence in the marketplace of the above-described product alternatives to natural solid wood lumber is that these materials exhibit properties like those of the equivalent natural solid wood lumber, especially the properties of retaining strength, durability, stability and finish under exposure to expected environmental and use conditions. A class of these alternative products are multilayer lignocellulosic products, such as multi-layer oriented wood strand particleboards, particularly those with a layer-to-layer oriented strand pattern, such as OSB.

Oriented, multilayer wood strand boards are composed of several layers of thin wood strands. Wood strands are wood particles having a length, which is several times greater than their width. These strands are formed by slicing larger wood pieces of wood so that the fiber elements in the strands are substantially parallel to the strand length. The strands in each layer are positioned relative to each other with their length in substantial parallel orientation and extending in a direction approaching a line, which is parallel to one edge of the layer. The layers are positioned relative to each other with the oriented strands of adjacent layers perpendicular, forming a layer-to-layer cross-oriented strand pattern. Oriented, multilayer wood strand boards of the above-described type are described in detail in the following U.S. Pat. Nos: 3,164,511, 4,364,984, 5,435,976, 5,470,631, 5,525,394, and 5,718,786, all of which are incorporated herein by reference.

Lignocellulosic materials contain a variety of both hazardous and non-hazardous volatile and semi-volatile organic compounds. A portion of these compounds is released when the lignocellulosic material is treated in manufacturing processes. Typical processing activities that cause the emission of the above-described compounds include, but are not limited to, flaking, drying, blending, forming, and pressing.

VOC emissions are formed from heating lignocellulosic materials and adhesive resin under pressure in a product formation press. Therefore, a major problem exists in that VOC have now become significant atmospheric pollutants under relatively high gas pressures. Thus, when VOC pollutants are released at high pressure from a formation press after volatilizing same, the quantity of unwanted contaminants in the atmosphere is substantially increased. Further, new environmental standards currently being promulgated will require those facilities that currently do not have press emission treatment systems, to capture and recover Hazardous Air Pollutant emissions (HAP) and treat them in accordance with air permits managed by regulatory agencies. In considerable numbers of cases, the amount of the released VOC and HAP is above a level, which is acceptable under governmental air quality standards.

For example, in oriented strand board (OSB) mills, green lignocellosic material is flaked, dried, and blended with resins and wax, formed into mats, which are multi-layer in structure, and then pressed in continuous or multi-opening presses at relative high temperature and pressure. During the drying and pressing steps of the manufacturing process for OSB, VOC and HAP and semi-VOC compounds are released to the atmosphere. These emissions are released to the atmosphere during the entire continuous de-compression cycle of a multi-opening pressing sequence.

In a number of commercial OSB manufacturing facilities, VOC and HAP emissions are captured by enclosing the loader tray, press and unloader tray within a large walled area (“press enclosure”). Then, a significant volume of air is removed from that enclosure and is sent to a regenerative thermal oxidizer (“RTO”) for destructive oxidation of the VOC and HAP emissions contained in that air stream.

A portion of the VOC and HAP emissions released into the press enclosure condense onto the enclosure walls and the formation press surfaces, collecting particulate matter, and creating a potential fire hazard that must be cleaned off during scheduled maintenance shutdowns. For example, formaldehyde and methanol are primary pollutants for OSB facilities.

End of pipe air pollution controls are expensive in two respects. First, the cost of the initial equipment. Second, annual operation and maintenance costs are quite expensive.

It is difficult and expensive to find best available control technologies (BACT) that can manage high volume air flow while still achieving significant VOC and HAP capture and treatment. Some existing BACT focus on collecting the VOC and HAP in another media (water, carbon, adsorption media, etc.) while allowing the treated air to be discharged. Other technologies employ direct thermal oxidation of the entire gas stream without any attempt at concentration of the VOC and HAP.

U.S. Pat. No. 2,268,477 is directed to a press for drying and heat-bonding to form laminated materials. The press comprises platens having narrow grooves extending across the working face of the platen for venting steam produced during pressing of wood veneer and thereby allowing same to be released from the press to the atmosphere. A grooved platen and perforated plate may be used together to form a pathway for the steam to be released. For example, “numerous tiny grooves” can be provided which extend entirely across the platen from one edge to another.

U.S. Pat. No. 4,850,849 describes a press apparatus in which steam, from an external source which is injected into the press apparatus, is employed in sealing and pressing a mat of compressible material and binder, and forming same into a final product. Steam sealing of the press is facilitated by a press border projection. The press includes an upper press platen and a lower press platen. Steam is passed from the upper press platen through the mat for purposes of curing the binder. VOC produced during the curing of the binder can be retained within the confines of the platens or released to atmosphere during the steam pressing operation from the lower press platen. Alternatively, a portion of the steam can be evacuated from the confines of the press apparatus after the steam injection step has been concluded.

U.S. Pat.No. 5,749,160 relates to a system for controlling VOC emissions in a wafer drying system, which includes using VOC exhaust as combustion gas in a burner, which indirectly heats thermal oil used to heat the press used for waferboard manufacture.

U.S. Pat. No. 5,989,465 describes a system for manufacturing board product including drying lignocellulosic material in a first and second dryer. The lignocellulosic material is formed into a mat which is hot pressed utilizing the pressed air stream from the hot pressing step and a supply of air as the source of drying air for the first and second dryers. The exhaust air from the second dryer is used as a source of drying air in the first dryer. The exhaust air from the first dryer is used as a source of drying for the first dryer and as a source of combustion air in a furnace.

In cases where the VOC released to the atmosphere, such as described in U.S. Pat. Nos. 2,268,477 and 4,850,849, it can constitute a violation of air quality standards. The typical commercial solution in these situations is to construct a large, airtight enclosure, which surrounds the product formation press and retains the VOC emitted from the press therewithin. This airtight enclosure contains not only the VOC, but also includes extremely large volume of atmospheric gases in the form of dilution air. Thus, this extremely large volume of dilution air and VOC emissions which is confined within the enclosure must be evacuated to the plant RTO system where it is treated or destroyed along with other plant emissions. Typical enclosures of the type described above have a 100 feet×20 feet cross-section and are two stories high.

If the emissions from the above-described enclosure are to be combusted, gas quality of the enclosure emissions to be used, as fuel must be considered. A problem which results from the use of this technology is that the fuel value of the enclosure emissions is relatively low due to the presence of large amounts of non-combustible dilution air.

When an enclosure of the type described above is employed, another problem present in existing manufacturing facilities can be exacerbated. This problem relates to the negative air pressure created in the enclosure, which is caused by the evacuation of the contaminated vapor therefrom. The resultant excess negative air pressure must then be further dealt with at substantial cost to the manufacturer.

When the pressing operation is completed, and the press is opened, extremely large volumes of contaminated vapors are typically released. In general, an average flow rate of from about 100,000 to 200,000 CFM of contaminated vapors must therefore be evacuated from the above-described enclosure. The above-described prior art evacuation procedure is also, in and of itself, a costly procedure to perform.

Another difficulty associated with prior art systems is lower product throughput. Due to the increase in compression and degassing time, substantial increases are experienced in production time, and thus there are corresponding reductions in product throughput.

When most prior art systems are employed, blow and blister problems can also occur. More specifically, due to the high volume of vapor trapped in the mat during the pressing process, portions of the board surface may blister or blow open when the pressure of the press is released. In that case, the resulting board will be unsuitable for sale to customers.

Also, a fire hazard can be created in the product formation work area by flammable materials, such as wax or the like, which are used in the creation of the mat. These flammable materials can, for example, be spewed from the press into the area immediately surrounding the press. When an airtight enclosure as described above is employed, this flammable material can coat the enclosure walls as well. Due to the dangerous nature of these flammable contaminants, the area surrounding the press, and within the enclosure, must be repeatedly cleaned as a safety precaution. Conducting these clean-up procedures is quite costly to an end user from both a manpower and a mat production throughput standpoint.

Accordingly, there is a need for a method, which overcomes the above-described problems.

All of the U.S. patents cited above are incorporated herein by reference in their entirety.

### SUMMARY OF THE INVENTION

This invention is directed to a method and a system for recovering VOC emissions formed during the production of a lignocellulosic product.

The present invention more specifically relates to a method for with-drawing and recovering VOC and HAP emissions during the formation of a mat of lignocellulosic material, the mat preferably comprising a plurality of layers of lignocellulosic material and forms a multi-layer product. The mat is bonded together by an adhesive material, typically using heat and pressure, in a product formation press. The VOC and HAP emissions are produced during the formation of the mat in the product formation press.

The steps of withdrawing the VOC and HAP emissions and of recovering the VOC and HAP emissions, as hereinafter described, can include the step withdrawing and recovering VOC and HAP emissions which may be released from the product formation press prior to recovery. It can therefore be desirable to have channels for withdrawing VOC and HAP emissions located outside the outer boundary of the mat to withdraw any emissions which pass from the mat and are released from within the confines of the press toward the atmosphere surrounding the formation press. These channels in the system can be located so that they extend beyond the periphery of the outer dimension of the product, and are in communication with product formation press, for purposes of withdrawing releasing VOC and HAP emissions from the press system.

However, in a preferred form of this invention, the product formation press is designed to be substantially closed to the surrounding atmosphere to contain the VOC and HAP emissions, and to substantially prevent same from being released from within the emission control system and thereby polluting the adjoining environment. By providing such a substantially closed emission control system, the quantity of dilutant air that enters into the product formation press from the adjacent surroundings is significantly minimized, and in most cases eliminated. More specifically, the amount of air within the product formation press during the formation of said lignocellulosic product is typically reduced by at least about 50%, preferably by at least about 60%, more preferably by at least about 70%, and most preferably by at least about 80%, of the amount of air within the product formation press during the production of a comparable lignocellulosic product which is produced without withdrawing said VOC and HAP emissions from the product formation press during the production of the comparable lignocellulosic product.

Preferably, the product is particleboard or fiberboard. More preferably, the product comprises is formed of a multilayer construction. Most preferably, the product is an oriented strand board product.

An advantageous feature of the present invention is that higher moisture content lignocellulose can be employed in the mat during formation of the product. This enables production of products at reduced cost using highly diluted chemicals without the necessity of re-drying the lignocellulosic material.

This further significantly reduces the risk of formation press blows during product formation. It also significantly reduces the risk of product blistering.

Furthermore, this significantly reduces the need to dry the lignocellulosic material in order to maintain it's moisture level below the moisture content threshold of the lignocellulosic material for generating an environmentally unacceptable VOC and HAP level in the formation press. And, since the fines fraction of the lignocellulosic material is prone to being over-dried during the above-described drying operation, screening of the fines before drying must be provided to overcome these problems which adds cost and additional pollutants to the system.

The method of this invention reduces the fire hazard in the formation press area because of less build-up from wax and other flammable organic compounds. Also, the fire hazard is reduced because the lignocellulosic material is not over-dried due to the need to reduce the moisture content.

The moisture content of the lignocellulosic product is typically greater than the moisture content of a lignocellulosic product, which is produced without withdrawing of the VOC and HAP emissions from said formation press. For purposes of this invention, a value of 6% moisture content has been employed for the moisture content of a lignocellulosic product, which is produced without withdrawing of the VOC and HAP emissions from the formation press based on the research findings of the Institute of Paper Science and Technology. Accordingly, the moisture content in the mat prior to the formation of the lignocellulosic product is typically more than about 6% by weight, preferably at least about 8% by weight, more preferably at least about 10% by weight, most preferably at least about 12% by weight, based on the weight the mat.

Preferably, the VOC and HAP emissions which are withdrawn from the formation press during the formation of the product are recovered without being released to the atmosphere. The VOC and HAP emissions are preferably recovered continuously, without being substantially released to the atmosphere, continuously as they are withdrawn from the formation press during the formation of the mat. Preferably, the VOC and HAP emissions are withdrawn from the formation press under vacuum.

Typically, the step of withdrawing the VOC and HAP emissions from the formation press during the formation of the mat commences no later than when the VOC and HAP emissions are formed. Furthermore, the step of withdrawing the VOC and HAP emissions from the formation press during the formation of the mat typically commences when the mat is heated to a temperature, which initiates the formation of the VOC and HAP emissions.

In the method of this invention, the amount of the VOC and HAP emissions that are produced during the formation of the lignocellulosic product, and are withdrawn from said formation press, prior to removal of said lignocellulosic product from said formation press, is typically at least about 50% by weight, preferably at least about 60% by weight, more preferably at least about 70% by weight, and most preferably at least about 80% by weight.

The vapor pressure in the formation press during the formation of the subject lignocellulosic product by the method of this invention is substantially less than the vapor pressure in a formation press during the formation of a lignocellulosic product, which is conducted without withdrawing VOC and HAP emissions as in the method of the present invention. Since VOC and HAP emissions are withdrawn from the formation press during the course of the subject invention, the vapor pressure in the formation press preferably does not exceed about 10 psi, more preferably does not exceed about 5 psi, and most preferably does not exceed about 2 psi, during the formation of the lignocellulosic product.

The method of the present invention minimizes press time by eliminating the requirement of long decompression time and/or long degassing time experienced by the prior art compression presses. The time for decompressing and/or degassing the subject lignocellulosic product is typically at least about 60%, preferably at least about 70%, more preferably at least about 80%, and most preferably at least about 90%, less than the cycle time to form a lignocellulosic product which is produced without withdrawing of the VOC and HAP emissions from the formation press.

Preferably, no steam is introduced into the formation press, during the production of the product, from a source outside the formation press. The press system is preferably heated by circulating thermal oil rather than steam.

The subject system can define a product formation press and a plurality of channels in commication with the product formation press for withdrawing the VOC and HAP emissions from the product formation press. The VOC and HAP emissions can then be removed during the formation of the mat as the VOC and HAP emissions are withdrawn through the plurality of channels.

This present invention is also directed to an apparatus for recovering and controlling VOC and HAP emissions. This apparatus comprises an emission control system for recovering and controlling VOC and HAP emissions during the formation of a mat of lignocellulosic material by withdrawing these emissions from the product formation press. Again, this mat is typically bonded together by an adhesive material using heat and pressure.

This emission control system, as well as other emission systems described herein, can include at least one platen. Preferably, an emission control system of this invention includes a plurality of platens.

As previously provided, the product formation press of a preferred embodiment of the present invention is substantially closed to the surrounding atmosphere. In this way, the amount of dilutant air flowing into the product formation press during the formation of the lignocellulosic product can be substantially curtailed. To this end, an apparatus is connected to the product formation press for substantially closing the product formation press to the surrounding atmosphere. Typically, this apparatus is a projecting flange. The projecting flange preferably extends about the periphery of the product formation press so that it substantially closes the emission control system with respect to the surrounding atmosphere. This projecting flange is typically connected to at least one platen, and preferably engages at least one platen. More preferably, the projecting flange is connected to one platen, most preferably the upper platen, and engages, but is not joined to, at least one platen, most preferably the lower platen.

The system for recovering and controlling VOC and HAP emissions from the emission control system can also be connected to the projecting flange. Furthermore, an assembly can be provided for sealingly engaging the apparatus within the product formation press.

The press system of the subject invention preferably includes screens, designed to continuously release VOC and HAP emissions from the mat being pressed. A screen can be used to facilitate vapor dissipation. When pressing occurs, vapor dissipates from mat through screen, and passes from the press system through the evacuation channels, to a collection pipe. Moreover, the emission control system preferably includes a least one screen, typically a caul screen, and more preferably, the emission control system more preferably includes a plurality of screens.

The method of this invention can also include the step of condensing the VOC and HAP emissions withdrawn from the formation press, and then recovering the condensed VOC and HAP emissions. Moreover, the subject method can include the step of combusting the VOC and HAP emissions which have been removed from the formation press, preferably condensed VOC and HAP emissions, typically in a burner or the like. In these cases, the VOC and HAP emissions which are withdrawn from said formation press are preferably continuously condensed and/or combusted.

Benefits of the present invention include a reduction in the total airflow required for collecting the pressing operation and a corresponding abatement of VOC and HAP therefrom. Since the resultant volume of VOC and HAP emissions retained in the formation press is substantially diminished, the recovered VOC and HAP emissions can be substituted for ambient air in the bio-mass combustion burners used to generate thermal energy in the product manufacturing. This turns the existing thermal energy sources into continuous thermal oxidizers of the recovered VOC and HAP emissions, which in turn eliminates the need to install RTO units for the VOC and HAP emission recovery.

Furthermore, the amount of ambient air which passes through the formation press in the production of the lignocellulosic product of this invention is reduced. The amount of ambient air which passes through the formation press in the production of the lignocellulosic product is typically reduced by at least about 50%, preferably reduced by at least about 60%, more preferably reduced by at least about 70%, and most preferably reduced by at least about 80%, of the amount of ambient air which passes through a formation press employed in the production of a comparable lignocellulosic product which is produced without withdrawing said VOC and HAP emissions from said formation press during the production of the comparable lignocellulosic product.

The foregoing and other objects, features and advantages of the invention will become more apparent from the detailed description of a preferred embodiment of the invention below which proceeds with reference to the accompanying drawings.

### DESCRIPTION OF THE DRAWINGS

In FIG. 1 is a schematic view of a preferred overall VOC and HAP recovery system 100 of the present invention, which can include any of the preferred emission control systems 10-10g of FIGS. 2-9.

FIG. 2 is an end view of emission control system 10 of this invention.

FIG. 3 is an end view of an emission control system 10a of this invention.

FIG. 4 is an end view of an emission control system 10b of this invention.

FIG. 5 is an end view of an emission control system 10c of this invention.

FIG. 6 is an end view of an emission control system 10d of this invention.

FIG. 7 is an end view of an emission control system 10e of this invention.

FIG. 8 is an end view of an emission control system 10f of this invention.

FIG. 9 is an end view of an emission control system 10g of this invention.

### DETAILED DESCRIPTION OF THE PRESENT INVENTION

The term “lignocellulosic product”, as used herein, can describe a number of lignocellulosic board products, preferably including multi-layer lignocellulosic board products. A primary example of such a lignocellulosic board product is particleboard or fiberboard. A primary example of such a multi-layer lignocellulosic board product is OSB.

The lignocellulosic products of this invention can be prepared by application of an adhesive bonding material to lignocellulosic material such as particles, chips or wafers, more specifically wood particles, wood chips and lignocellulosic fibers. Preferably the lignocellulosic material is formed into layers. Similarly, the method of the present invention and its attendant advantages can be achieved with respect to various forms of lignocellulosic starting material and is not limited to any particular form. The use of wood particles and wafers, for example, in the formation of a typical OSB product comprises the preferred environment for the method of the present invention.

Mixtures of lignocellulosic particles may also be used. Typically, such materials are wood particles derived from wood and wood residues such as wood chips, wood fibers, shavings, veneers, wood wool, cork, bark, sawdust, and the like. Particles of other lignocellulosic material such as shredded paper, pulp or vegetable fibers such as corn stalks, straw, bagasse and the like may also be used.

Adhesive is typically blended with the above lignocellulosic materials using rotary blenders to achieve thorough mixing and dispensing of the adhesives. The adhesive bonding system of the present invention generally comprises an isocyanate polymer and/or an aldehyde polymer resin. The adhesive bonding system can also be an isocyanate/latex copolymer or a phenol-formaldehyde/latex copolymer. The polymers, which form the adhesive bonding system, are typically in liquid form so that they can be applied directly to a major surface of a layer of lignocellulosic material. The polymer resins can be combined together prior to their application.

The aldehyde polymer resins can comprise thermosetting resins such as phenol-formaldehyde, resorcinol-formaldehyde, melamine-formaldehyde, urea-formaldehyde, modified lignosulfonates, urea-furfural and condensed furfuryl alcohol resins. The phenolic component can include any one or more of the phenols which have heretofore been employed in the formation of phenolic resins and which are not substituted at either the two ortho-positions or at one ortho- and the para-position, such unsubstituted positions being necessary for the polymerization reaction. Any one, all, or none of the remaining carbon atoms of the phenol ring can be substituted. The nature of the substituent can vary widely, and it is only necessary that the substituent not interfere in the polymerization of the aldehyde with the phenol at the ortho- and/or para-positions. Substituted phenols employed in the formation of the phenolic resins include: alkyl-substituted phenols, aryl-substituted phenols, cyclo-alkyl-substituted phenols, alkenyl-substituted phenols, alkoxy-substituted phenols, aryloxy-substituted phenols, and halogen-substituted phenols, the foregoing substituents containing from 1 to 26 and preferably from 1 to 12 carbon atoms. Specific examples of suitable phenols include: phenol, 2,6 xylenol, o-cresol, m-cresol, p-cresol, 3,5-xylenol, 3-4-xylenol, 2,3,4-trimethyl phenol, 3-ethyl phenol, 3,5-diethyl phenol, p-butyl phenol, 3,5-dibutyl phenol, p-amyl phenol, p-cyclohexyl phenol, p-octyl phenol, 3,5-dicyclohexyl phenol, p-phenyl phenol, p-crotyl phenol, 3,5-dimethoxy phenol, 3,4,5-trimethoxy phenol, p-ethoxy phenol, p-butoxy phenol, 3-methyl-4-methoxy phenol, and p-phenoxy phenol.

The aldehydes reacted with the phenol can include any of the aldehydes heretofore employed in the formation of phenolic resins such as formaldehyde, acetaldehyde, propionaldehyde, furfuraldehyde, and benzaldehyde. In general, the aldehydes employed have the formula R′CHO wherein R′ is a hydrogen or a hydrocarbon radical of 1 to 8 carbon atoms. The most preferred aldehyde is formaldehyde.

The isocyanate polymer may suitably be any organic isocyanate polymer compound containing at least 2 active isocyanate groups per molecule, or mixtures of such compounds. Generally, the isocyanate polymers employed in the method of this invention are those, which have an isocyanato group functionality of at least about two. Preferably, this functionality ranges from 2.3 to 3.5 with an isocyanate equivalent of 132 to 135. The isocyanato functionality can be determined from the percent available NCO groups and the average molecular weight of the isocyanate polymer composition. The percent available NCO groups can be determined by the procedures of ASTM test method D1638.

The isocyanate polymers which can be employed in the method of the present invention can be those that are typically employed in adhesive compositions, including typical aromatic, aliphatic and cycloaliphatic isocyanate polymers. Representative aromatic isocyanate polymers include 2,4-tolylene diisocyanate, 2,6-tolylene diisocyanate, 4,4′-methylene bis(phenyl isocyanate), 1,3-phenylene diisocyanate, triphenylmethane triisocyanate, 2,4,4′-triisocyanatodiphenyl ether, 2,4-bis(4-isocyanatobenzyl) phenylisocyanate and related polyaryl polyiscocyanates, 1,5-naphthalene diisocyanate and mixtures thereof. Representative aliphatic isocyanate polymers include hexamethylene diisocyanate, xylylene diisocyanate, and 1,12-dodecane diisocyanate and lysine ethyl ester diisocyanate. Representative cycloaliphatic isocyanate polymers include 4,4′-methylenebis (cyclohexyl isocyanate), 1,4-cyclohexylene diisocyanate, 1-methyl-2, 4-cyclohexylene diisocyanate and 2,4-bis(4-isocyanatocyclhexylmethyl) cyclohexyl isocyanate.

The isocyanate polymer is typically applied in its liquid form. Generally, when a phenol-formaldehyde resin is used as the phenolic resin it is present in the adhesive composition used in the method of the present invention within the range of about 50 to 90% by weight, preferably within the range of about 60 to 80% by weight of the total amount of adhesive. Generally, the isocyanate polymer is present in an amount of about 5% to 40% isocyanate polymer, preferably 10 to 35% isocyanate polymer, and most preferably 15 to 30% isocyanate polymer, by weight. When the adhesive bonding system is used according to these percentages, one achieves a commercially attractive combination of desired board properties and economic advantages.

The preferred formation of the layers of lignocellulosic material typically involves the application of an adhesive bonding composition to the lignocellulosic material with subsequent application of heat and pressure to form the layers into its desired consolidated configuration. It should be appreciated that the adhesive composition can be applied to the lignocellulosic particles in any conventional means, such as spraying of the adhesive composition onto the lignocellulosic particles.

Various emission control systems can be employed in the practice of the present invention. In each case, at least one of the lower and upper platen is capable of withdrawing the VOC and HAP emissions produced during the formation of the lignocellulosic product prior to removal of said lignocellulosic product from said product formation press.

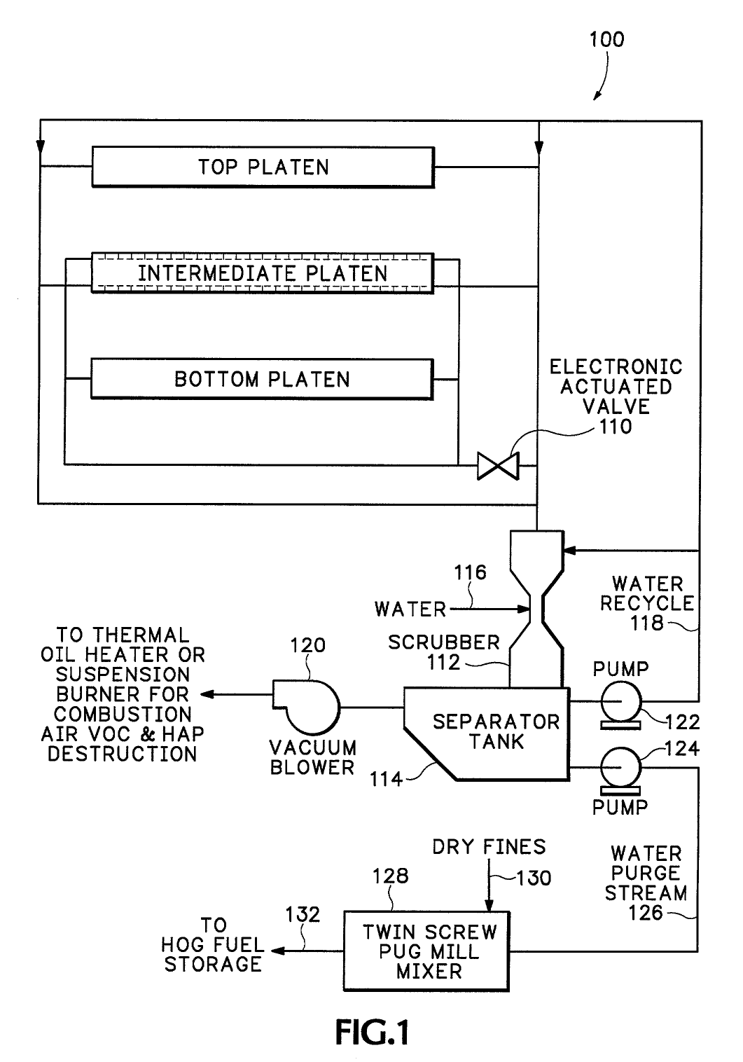

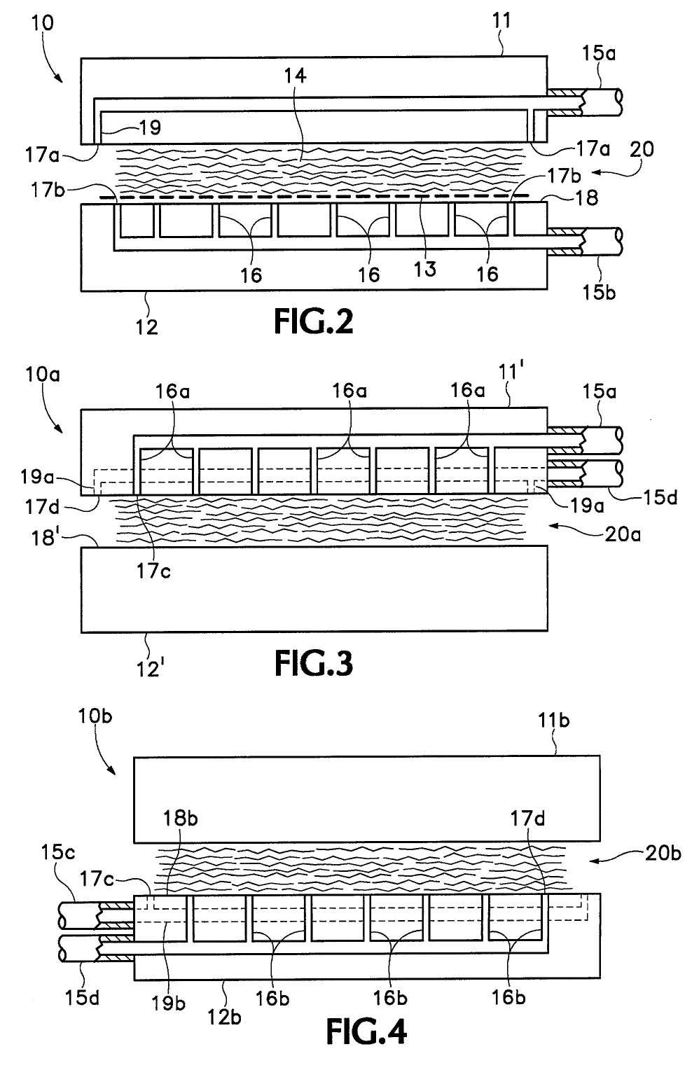

In FIG. 1, a preferred overall VOC and HAP recovery system 100 of the present invention is depicted, which includes preferred emission control system 10 described below. The system 100 can comprise, for instance, the emission control system 10 of FIG. 2, which includes upper platen 11 and lower platen 12 defining therewithin a product formation press 20. It can also include, if desired, a plurality of additional intermediate upper and lower platens (not shown). These intermediate upper and lower platens can have the same configuration as the upper and lower platens as hereinafter described in FIGS. 2-6. The platens can also comprise various other combination of configurations in which the structure of the platens is either perforated or non-perforated, provided that at least one of the platens includes is designed for withdrawing VOC and HAP emissions from the product formation press as hereinafter described.

In system 100, VOC and HAP emissions withdrawn from a product formation press introduced into a recovery system. As shown in FIG. 1, the VOC and HAP emissions are withdrawn by electronic actuated valve 110, through a scrubber 112 and into a separator tank 114 where they are condensed and separated from the aqueous and solid fractions, which is withdrawn. Water is introduced into the scrubber through water line 116 and recycle water line 118. In separator tank 114, the VOC and HAP are removed by vacuum blower 120 and conveyed for combustion. Typically, a thermal oil heater or suspension burner (not shown) is employed to conduct the combustion operation. An aqueous fraction is removed from the separator tank 114 by pump 122 and recycled to the scrubber 112. A solid fraction, in the form of water purge stream 126, is pumped by pump 124 to twin screw pug mill mixer 128, where dry fines 130 are added. The stream exiting twin screw pug mill mixer 128 is transferred to a hog fuel storage facility 132.

In FIG. 2, for example, an end view of an emission control system 10 of the present invention is shown. System 10 comprises upper platen 11 and lower platen 12 defining therewithin a product formation press 20. A screen 13 is located on upper surface 18 of lower platen 12. The screen 13 supports a mat 14 comprising lignocellulosic particles and adhesive resin mat during the heating and pressing thereof. A channel 19 in platens 11 is located outside the extent of the mat 14 for withdrawing emissions which are otherwise released from the outer edges A of the mat 14. Channels 16 of platen 12 are located within the extent of the perimeter of mat 14. Channel 19 and channels 16 permit the VOC and HAP produced in the pressing operation to be withdrawn from within the press 20 to the passageways 15a and 15b of platens 11 and 12, respectively, and in turn out of the system 10. Upper and lower platens 11 and 12 include respective apertures 17a and 17b, which in turn are in communication with passageways 15a and 15b, respectively.

In FIG. 3, an end view of another emission control system 10a of the present invention is shown. System 10a comprises upper platen 11′ and lower platen 12′. The lower platen 12′ is non-perforated and does not include a passageway system for withdrawing VOC and HAP from the system 10a. Upper platen 11′ and lower platen 12′ together define therewithin a product formation press 20a. Located on the upper surface 18′ of lower platen 12′ is a mat 14 comprising lignocellulosic particles and adhesive resin mat which is supported thereon during the heating and pressing thereof. Channels 16a of platen 11′, located within the extent of the perimeter of mat 14, permit VOC and HAP produced in the pressing operation to be withdrawn from within the press 20a to the passageway 15c of platen 11′, and in turn out of the system 10a. A channel 19a in platen 11′ is located outside the extent of the mat 14 for withdrawing emissions through passageway 15d which are otherwise released from the outer edges A of the mat 14. Upper platen 11′ includes respective apertures 17c and 17d, which in turn are in communication with passageways 15c and 15d, respectively.

FIG. 4 has the same platen configuration as FIG. 3 except that the upper and lower platens are reversed. In FIG. 4, an end view of another emission control system 10b of the present invention is shown. System 10b comprises upper platen 11b and lower platen 12b. The upper platen 12b is non-perforated and does not include a passageway system for withdrawing VOC and HAP from the system 10b. Upper platen 11b and lower platen 12b together define therewithin a product formation press 20b. Located on the upper surface 18b of lower platen 12b is a mat 14 comprising lignocellulosic particles and adhesive resin mat which is supported thereon during the heating and pressing thereof. Channels 16a of platen 12b, are located within the extent of the perimeter of mat 14, and permit VOC and HAP produced in the pressing operation to be withdrawn from within the press 20b to the passageway 15c of platen 12b, and in turn out of the system 10a. A channel 19b in platen 11b is located outside the extent of the mat 14 for withdrawing emissions through passageway 15d which are otherwise released from the outer edges A of the mat 14. Upper platen 11′ includes respective apertures 17c and 17d, which in turn are in communication with passageways 15c and 15d, respectively.

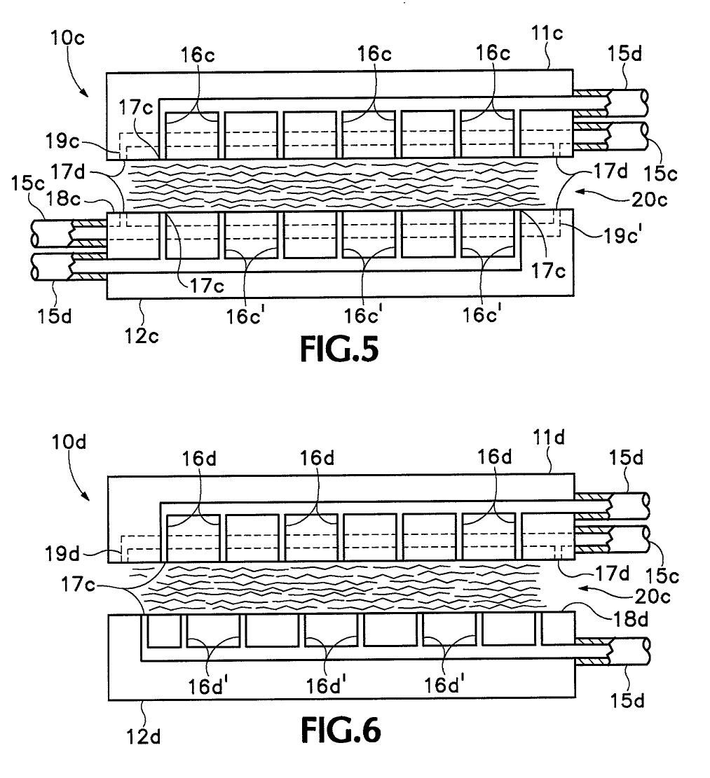

In FIG. 5, an end view of another emission control system 10c of the present invention is shown. System 10c comprises upper platen 11c and lower platen 12c. Upper platen 11c and lower platen 12c together define therewithin a product formation press 20c. Located on the upper surface 18c of lower platen 12c is a mat 14 comprising lignocellulosic particles and adhesive resin mat which is supported thereon during the heating and pressing thereof. Channels 16c and 16c′ of platens 11c and 12c, are located within the extent of the perimeter of mat 14, and permit VOC and HAP produced in the pressing operation to be withdrawn from within the press 20c to the passageway 15c of platen 12c, and in turn out of the system 10c. Channels 19c and 19c′ in platen 11c and 12c are located outside the extent of the mat 14 for withdrawing emissions through passageway 15d which are otherwise released from the outer edges A of the mat 14. Upper platen 11c and lower platen 12c include respective apertures 17c and 17d, which in turn are in communication with passageways 15c and 15d, respectively.

In FIG. 6, an end view of another emission control system 10d of the present invention is shown. System 10d comprises upper platen 11d and lower platen 12d. Upper platen 11d and lower platen 12d together define therewithin a product formation press 20d. Located on the upper surface 18d of lower platen 12d is a mat 14 comprising lignocellulosic particles and adhesive resin mat which is supported thereon during the heating and pressing thereof. Channels 16d and 16d′ of platens 11d and 12d, are located within the extent of the perimeter of mat 14, and permit VOC and HAP produced in the pressing operation to be withdrawn from within the press 20d to the passageway 15c of platen 12d, and in turn out of the system 10d. Channel l9d in platen 11d is located outside the extent of the mat 14 for withdrawing emissions through passageway 15d which are released from the outer edges A of the mat 14. Upper platen 11d includes respective apertures 17c and 17d, which in turn are in communication with passageways 15c and 15d, respectively. Lower platen 12d includes apertures 17c, which in turn are in communication with passageways 15c.

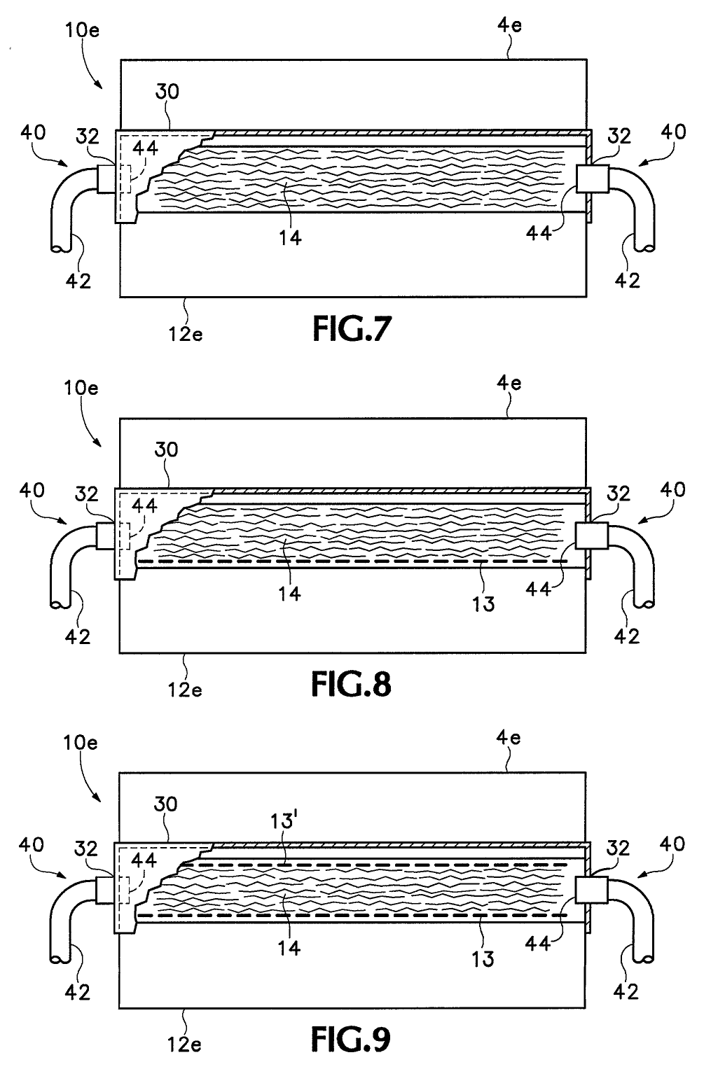

In FIGS. 7-9, an end view of another emission control systems 10e-10g of the present invention is shown. Systems 10e-10g comprise respectively upper platen 11e-11g and lower platen 12e-12g. The respective upper platens 11e-11g and the lower platens 12e-12g are non-perforated and do not include a passageway system for withdrawing VOC and HAP from the systems 10e-10g.

Any of the above systems 10-10d can include first and/or second screens 13 and/or 13′. The first screen 13 would be located on the upper surface of the lower platen on the bottom of the mat 14, and the second screen 13′ would be located adjacent the lower surface of upper platen on the top of the mat 14 (see for example FIGS. 2 and 3). Furthermore, in system 10e of FIG. 7, there is no screen depicted. On the other hand, in system 10f of FIG. 8, first screen 13 is shown, and in system 10g of FIG. 9, first screen 13 and second screen 13′ are provided.

Located on the upper surface 18e of lower platen 12e of system 10e is a mat 14 comprising lignocellulosic particles and adhesive resin mat which is supported thereon during the heating and pressing thereof. Furthermore, also located on the first screens 13, which are supported by the upper surfaces 18f and 18g of lower platens 12f and 12g of respective systems 10f and log, are mats 14 comprising lignocellulosic particles and adhesive resin. These mats are supported on the screens during the heating and pressing thereof.

The emission control systems 10e-10g differ from emission control systems 10a-10d in that respective product formation presses 20e-20g are substantially closed to the surrounding atmosphere. Thus, the amount of dilutant air flowing into the product formation presses 20e-20g during the formation of the lignocellulosic product can be substantially curtailed. More specifically, an apparatus in the form of projecting flange 30 is connected to the product formation press 20e-20g for substantially closing the product formation press to the surrounding atmosphere. As shown in FIGS. 7-9, the projecting flange 30 extends about the periphery of the product formation presses 20e-20g. The projecting flange 30 of FIGS. 7-9, which is typically connected to at least one platen of product formation presses 20e-20g, are connected to upper platens 11e-11g. This connection can be accomplished using, for instance, conventional fasteners such a bolt-nut assembly, or by welding. The projecting flange 30 of FIGS. 7-9, which typically engages at least one platen of product formation presses 20e-20g, also engages, but is not joined to, lower platens 12e-12g. In this way, the respective product formation presses 20e-20g are substantially closed to the surrounding atmosphere.

In the systems 10a-10d of FIGS. 2-6, channels 16-16d′ of platens 12-12d, respectively, permit the VOC and HAP produced in the pressing operation to be withdrawn from within the product formation presses 20-20d to the passageways 15a-15d, respectively, and in turn out of the systems 10a-10d. An emission recovery system 40, each system 40 comprising a conduit 42 and a connector 44, can also be attached through an apertures 32 disposed at various predetermined locations in the projecting flange 30 for recovering and controlling VOC and HAP emissions from product formation presses 20-20d.

1. A method for withdrawing and recovering VOC and HAP emissions in the production of a lignocellulosic product, which comprises:
forming a mat of lignocellulosic material;
bonding together said mat in a product formation press with an adhesive material to produce said lignocellulosic product, the product formation press being substantially closed to the surrounding atmosphere to contain the VOC and HAP emissions and to substantially prevent the VOC and HAP emissions from being released from within the emission control system;
forming VOC and HAP emissions during the production of said lignocellulosic product in said product formation press;
withdrawing at least about 50% of said VOC and HAP emissions produced during the formation of said lignocellulosic product prior to removal of said lignocellulosic product from said product formation press; and
recovering, without releasing to the atmosphere, said VOC and HAP emissions, which are withdrawn from said product formation press.

2. The method of claim 1, wherein said VOC and HAP emissions are continuously withdrawn from said product formation press during the formation of said lignocellulosic product.

3. The method claim 1, wherein said VOC and HAP emissions are continuously recovered during the formation of said lignocellulosic product.

4. The method of claim 1, wherein substantially no steam is introduced into said product formation press, from a source outside said product formation press, during the production of said lignocellulosic product.

5. The method of claim 1, wherein the step of withdrawing said VOC and HAP emissions from said product formation press during the formation of said lignocellulosic product commences no later than when said VOC and HAP emissions are formed.

6. The method of claim 1, which further includes the step of withdrawing prior to the recovery step a substantial portion of said VOC and HAP emissions from said emission control system.

7. The method of claim 1, wherein the VOC and HAP emissions are withdrawn from said product formation press under vacuum.

8. The method of claim 1, which further includes the step of condensing said VOC and HAP emissions, which have been withdrawn from said product formation press.

9. The method of claim 1, which includes the step of combusting said VOC and HAP emissions which have been withdrawn from said product formation press.

10. The method of claim 1, wherein said product is selected from a group consisting of particleboard and fiberboard.

11. The method of claim 1, wherein said product comprises an oriented strand board.

12. The method of claim 1, wherein said product is a multilayer product.

13. The method of claim 1, wherein the amount of air within the product formation press in the production of the lignocellulosic product is reduced by at least about 50% of the amount of air within a product formation press employed in the production of a comparable lignocellulosic product which is produced without withdrawing said VOC and HAP emissions from said product formation press during the production of said comparable lignocellulosic product.

14. The method of claim 1, wherein the amount of ambient air which passes through the product formation press during the formation of said lignocellulosic product is reduced by at least about 50% of the amount of ambient air passing through the product formation press during the production of a comparable lignocellulosic product which is produced without withdrawing said VOC and HAP emissions from said product formation press during the production of said comparable lignocellulosic product.

15. The method of claim 1, wherein pressure in said product formation press does not exceed about 10 psi during the formation of said lignocellulosic product.

16. The method of claim 1, wherein moisture content of said mat prior to the formation of said lignocellulosic product in said product formation press is more than about 6% by weight, based on the weight said mat.

17. The method of claim 1, wherein time for decompressing and degassing said lignocellulosic product is at least about 60% less than the time for decompressing and degassing a lignocellulosic product which is produced without withdrawing of said VOC and HAP emissions during product formation.

18. The method of claim 1, wherein the emission control system comprises at least one platen.

19. The method of claim 1, wherein the emission control system comprises a plurality of platens.

20. The method of claim 1, wherein the emission control system includes at least one screen.

21. A method for recovering and controlling VOC and HAP emissions, which comprises:
forming a mat of lignocellulosic material, said mat being bonded together by an adhesive material in an emission control system, said emission control system defining a product formation press for withdrawing said VOC and HAP emissions from said product formation press, said product formation press being substantially closed to the surrounding atmosphere;
forming VOC and HAP emissions during the production of said mat in said emission control system;
withdrawing said VOC and HAP emissions during the formation of said mat by evacuating said VOC and HAP emissions and controlling VOC and HAP emissions from said emission control system; and
recovering said VOC and HAP emissions which are withdrawn from said emission control system.

22. The method of claim 21, wherein said VOC and HAP emissions are continuously withdrawn from said emission control system during the formation of said lignocellulosic product.

23. The method claim 21, wherein said VOC and HAP emissions are continuously recovered during the formation of said lignocellulosic product.

24. The method of claim 21, wherein substantially no steam is introduced into said emission control system, from a source outside said emission control system, during the production of said lignocellulosic product.

25. The method of claim 21, wherein the step of withdrawing said VOC and HAP emissions from said emission control system during the formation of said lignocellulosic product commences no later than when said VOC and HAP emissions are formed.

26. The method of claim 21, which further includes the step of withdrawing prior to the recovery step a substantial portion of said VOC and HAP emissions from said emission control system.

27. The method of claim 21, wherein the VOC and HAP emissions are withdrawn from said emission control system under vacuum.

28. The method of claim 21, which further includes the step of condensing said VOC and HAP emissions which have been withdrawn from said emission control system.

29. The method of claim 21, which includes the step of combusting said VOC and HAP emissions which have been withdrawn from said emission control system.

30. The method of claim 21, wherein said product is selected from a group consisting of particleboard and fiberboard.

31. The method of claim 21, wherein said product comprises an oriented strand board.

32. The method of claim 21, wherein said product is a multilayer product.

33. The method of claim 21, wherein the amount of ambient air which passes through the emission control system in the production of the lignocellulosic product is reduced by at least about 50% of the amount of ambient air which passes through a press apparatus employed in the production of a comparable lignocellulosic product which is produced without withdrawing said VOC and HAP emissions from said press apparatus during the production of said comparable lignocellulosic product.

34. The method of claim 21, wherein the amount of air within the product formation press during the formation of said lignocellulosic product is reduced by at least about 50% of the amount of air within the product formation press during the production of a comparable lignocellulosic product which is produced without withdrawing said VOC and HAP emissions from said product formation press during the production of said comparable lignocellulosic product.

35. The method of claim 21, wherein pressure in said emission control system does not exceed about 10 psi during the formation of said lignocellulosic product.

36. The method of claim 21, wherein the moisture content prior to the formation of said lignocellulosic product in said product formation press is more than about 6% by weight, based on the weight said mat.

37. The method of claim 21, wherein the time for decompressing and degassing said lignocellulosic product is at least about 60% less than the cycle time for decompressing and degassing a lignocellulosic product which is produced without withdrawing of said VOC and HAP emissions during product formation.

38. The method of claim 21, wherein the emission control system comprises at least one platen.

39. The method of claim 21, wherein the emission control system comprises a plurality of platens.

40. The method of claim 21, wherein the emission control system includes at least one screen.

41. An apparatus for recovering and controlling VOC and HAP emissions, which comprises:
an emission control system for recovering and controlling VOC and HAP emissions formed during the production of a mat of lignocellulosic material, said mat being bonded together by an adhesive material,
said emission control system defining a product formation press for withdrawing said VOC and HAP emissions from said product formation press,
said product formation press being substantially closed to the surrounding atmosphere; and
at least one system for recovering and controlling VOC and HAP emissions from said emission control system by withdrawing said VOC and HAP emissions during the formation of said mat by evacuation without releasing into the surrounding atmosphere said VOC and HAP which are withdrawn from said emission control system.

42. The apparatus of claim 41, wherein the emission control system comprises at least one platen.

43. The apparatus of claim 41, wherein the amount of air within the product formation press during the formation of said lignocellulosic product is reduced by at least about 50% of the amount of air within the product formation press during the production of a comparable lignocellulosic product which is produced without withdrawing said VOC and HAP emissions from said product formation press during the production of said comparable lignocellulosic product.

44. The apparatus of claim 41, wherein the emission control system includes at least one screen.

45. The apparatus of claim 41, wherein said product emission press includes a plurality of channels in communication with said product formation press for recovering and controlling said VOC and HAP emissions.

46. The apparatus of claim 41, wherein a projecting flange is connected to said product formation press for substantially closing said product formation press to the surrounding atmosphere.

47. The apparatus of claim 41, wherein said product formation press further includes a projecting flange for substantially closing said product formation press to the surrounding atmosphere.

48. The apparatus of claim 43, wherein a projecting flange is attached to at least one said plurality of platens for substantially closing said product formation press to the surrounding atmosphere.

49. The apparatus of claim 42, wherein a projecting flange attached to at least one said platen for substantially closing said product formation press to the surrounding atmosphere.

50. The apparatus of claim 46, wherein said system for recovering and controlling VOC and HAP emissions from said emission control system is connected to said projecting flange.

51. A system employed in conjunction with an emission control system for recovering and controlling VOC and HAP emissions during the formation of a lignocellulosic product, said emission control system defining a product formation press for withdrawing said VOC and HAP emissions from said product formation press, which comprises:
an apparatus for surrounding and substantially closing said product formation press so as to control the amount of dilutant air flowing into the product formation press during the formation of said lignocellulosic product,
said VOC and HAP emissions being withdrawn by evacuation during the formation of said mat for recovering and controlling VOC and HAP emissions from said emission control system without releasing said VOC and HAP which are withdrawn from said emission control system to the atmosphere.

52. The system of claim 51, wherein said apparatus further comprises system for withdrawing said VOC and HAP emissions being withdrawn by evacuation during the formation of said mat for recovering and controlling VOC and HAP emissions from said emission control system without releasing said VOC and HAP which are withdrawn from said emission control system to the atmosphere.

53. The system of claim 51, which further comprises an assembly for connecting said apparatus to said product formation press.

54. The system of claim 51, said product formation press includes at least one platen, and said system includes system for attaching said apparatus to each said platen.

55. The apparatus of claim 51, wherein said apparatus includes a projecting flange connected to said product formation press for substantially preventing the VOC and HAP emissions from being released to the surrounding atmosphere from within the emission control system.

56. The apparatus of claim 55, wherein said projecting flange is attached to at least one said plurality of platens for substantially closing said product formation press to the surrounding atmosphere.

57. The apparatus of claim 54, wherein said projecting flange is attached to at least one said platen for substantially closing said product formation press to the surrounding atmosphere.

58. The apparatus of claim 46, wherein said system for recovering and controlling VOC and HAP emissions from said emission control system is connected to said projecting flange.

59. The apparatus of claim 51, wherein the amount of air within the product formation press during the formation of said lignocellulosic product is reduced by at least about 50% of the amount of air within the product formation press during the production of a comparable lignocellulosic product which is produced without withdrawing said VOC and HAP emissions from said product formation press during the production of said comparable lignocellulosic product.

60. The apparatus of claim 51, wherein said projecting flange extends about the periphery of the product formation press so that it substantially closes the emission control system with respect to the surrounding atmosphere.
